(19) United States
(12) Patent Application Publication
(10) Pub. No.: US 2025/0135453 A1
(43) Pub. Date: May 1, 2025

(54) RAPID AND LOW-COST FABRICATION OF MICROFLUIDIC DEVICES USING LIQUID CRYSTAL DISPLAY-BASED PRINTING

(71) Applicant: Purdue Research Foundation, West Lafayette, IN (US)

(72) Inventors: Huachao Mao, West Lafayette, IN (US); Yujie Shan, West Lafayette, IN (US)

(21) Appl. No.: 18/933,494

(22) Filed: Oct. 31, 2024

Related U.S. Application Data
(60) Provisional application No. 63/546,681, filed on Oct. 31, 2023.

(51) Int. Cl. B01L 3/00; B33Y 10/00; B33Y 30/00

(52) U.S. Cl. CPC B01L 3/502707; B33Y 10/00; B33Y 30/00; B01L 2200/027; B01L 2300/0861; B01L 2300/0887

(57) ABSTRACT

A microfluidic device may be manufactured by printing a microchannel layer using the 3D printer. The microchannel layer may have an inlet and an outlet fluidly connected by at least one groove. A substrate layer may be spin coated with a clear resin. The printed microchannel layer may be placed onto the coated substrate such that the coated substrate layer covers at least one groove to form a microchannel. The microchannel layer and substrate layer may be heated and then cured with an ultraviolet light.

### CROSS REFERENCE TO RELATED APPLICATIONS

This application claims the benefit of U.S. Provisional Application No. 63/546,681 filed Oct. 31, 2023, which is hereby incorporated by reference in its entirety.

### GOVERNMENT FUNDING

This invention was made with government support under CNS-1726865 and CNS-1726865 awarded by the National Science Foundation. The government has certain rights in the invention.

### TECHNICAL FIELD

This disclosure relates to microfluidic devices and, in particular, to microfluidic devices and the fabrication thereof.

### BACKGROUND

Microfluidic devices have been widely investigated for various applications, specifically in the biomedical field, which involve manipulating cells at a sub-micron scale. However, the conventional lithography process with polydimethylsiloxane (PDMS) micro-molding process (soft lithography) involves numerous steps demanding high-end equipment and a cleanroom fueling up the cost and making it a time-consuming process.

### BRIEF DESCRIPTION OF THE DRAWINGS

The embodiments may be better understood with reference to the following drawings and description. The components in the figures are not necessarily to scale. Moreover, in the figures, like-referenced numerals designate corresponding parts throughout the different views.

FIG. 1 illustrates an example of a microfluidic device fabrication process.

FIG. 2 illustrates an example of a 3D printer enhanced for printing a microchannel layer.

FIG. 3 illustrates an example of a microfluidic device with branching microchannels.

FIG. 4 illustrates an example of a microfluidic device that mimics an artery.

FIG. 5 illustrates an example of a scanning electron microscope (SEM) image of a printed microchannel layer with different widths of grooves.

FIG. 6 illustrates a chart showing a relationship between designed widths and printed widths of different curing times.

FIG. 7 illustrates an example of a microchannel layer having grooves of various depths.

FIG. 8 illustrates an example of a printed microfluidic channel with and without cells and at various magnifications.

### DETAILED DESCRIPTION

Microfluidic devices are being widely utilized in multiple applications ranging from Electrophoresis, PCR amplification, drug encapsulation, delivery, DNA analysis, cell analysis, cell culture, and diagnosis to single-cell separation and manipulation. Microfluidic channels are inherently advantageous in portability, accessibility, and ease of use for these biomedical applications. Over the last decade, diverse materials and techniques have been presented to fabricate microfluidic channels with reasonable trade-offs between benefits and drawbacks.

Various materials were used in microfluidic devices, including Silicon, Glass, Polymers—Polydimethylsiloxane (PDMS), Polystyrene—Polymethylmethacrylate (PMMA), Hydrogel. Silicon offers excellent surface resilience, thermal conductivity, and solvents compatibility, but it is challenging to perform optical detection because of the absence of transparency. In contrast, glass is transparent, biocompatible and hydrophilic, but not cost-effective. Polymers such as PDMS are widely used as they are inexpensive, translucent, flexible, and appropriate for cell cultures and processing. Hydrogels are a recent appeal because of their meager cost, low toxicity, biocompatibility, flexibility, and commercial viability. Presently, the paper-based microfluidic channel has a lot of traction as a “use and throw” (disposable) device because it is inexpensive, easy to store, transport, and bulk manufacture. Nevertheless, the patterning channel on paper is complex and non-repeatable.

Diverse microfabrication processes are employed to fabricate microfluidic devices based on compatibility with materials, as mentioned earlier. For instance, the already established photolithography process for semiconductor devices can be used to make microchannels on silicon wafers using chemical etching; or by creating a mold using photolithography and then casting polymers such as PDMS or PMMA over the mold. However, the lithography process requires expensive equipment and cleanroom installations, which is not a very economical way to produce microfluidic devices for biomedical applications. It also needs an additional step to bond or affix the microchannel to another substrate like glass or silicon.

Additive Manufacturing (AM) or 3D printing delivers a more appealing option by making a three-dimensional object layer-by-layer. Compared to the lithography process, 3D printing is a fast and straightforward alternative. Among numerous AM processes, Fused Filament Fabrication is a widely used method, but it is still very challenging to achieve a smooth and narrow channel lower than 500 μm in width. Vat Photopolymerization (VPP) can directly fabricate highly transparent microfluidics with much higher resolution, up to 100 μm. However, the considerable light penetration depth of transparent resin inevitably over-cures the residual resin inside flow channels. In-situ transfer vat photopolymerization addressed this over curing issue by adding an extra customized platform.

The system and methods described herein employ a liquid crystal display (LCD) VPP 3D printer to fabricate an affordable multi-depth microfluidic device. In various experimentation, systematic characterization of the microchannel was performed to examine the printer's capability, such as determining the thickness and roughness of the channel, optimized curing time, curing temperature, and spin coating stage. The experimental results show that the LCD-based 3D printer can fabricate features down to a 35 μm resolution in the horizontal direction and a 10 μm resolution in the vertical direction. The system was further optimized to fabricate microfluidic devices with multiple depth channels to demonstrate its versatility, feasibility, and robustness. The LCD 3D printer offers an inexpensive and rapid way to fabricate microfluidic channels with a minimum width of approximately 100 μm. We demonstrated how it could be used for various cell manipulation by forming a single streamline of the cells.

Multiple microchannel patterns were materialized to indicate the flexibility and versatility of the proposed 3D printing approaches. Also, the SEM image with multiple channel widths and depths illustrates the capability of these LCD-based 3D-printed microchannels for numerous biomedical applications. We demonstrate microfluidic devices with 100 μm wide channels. After that, the formation of a single streamline of MDA-MB-231 TNBC cancer cells inside the 3D printed long microfluidic channels demonstrates cell diagnosis and manipulation opportunities.

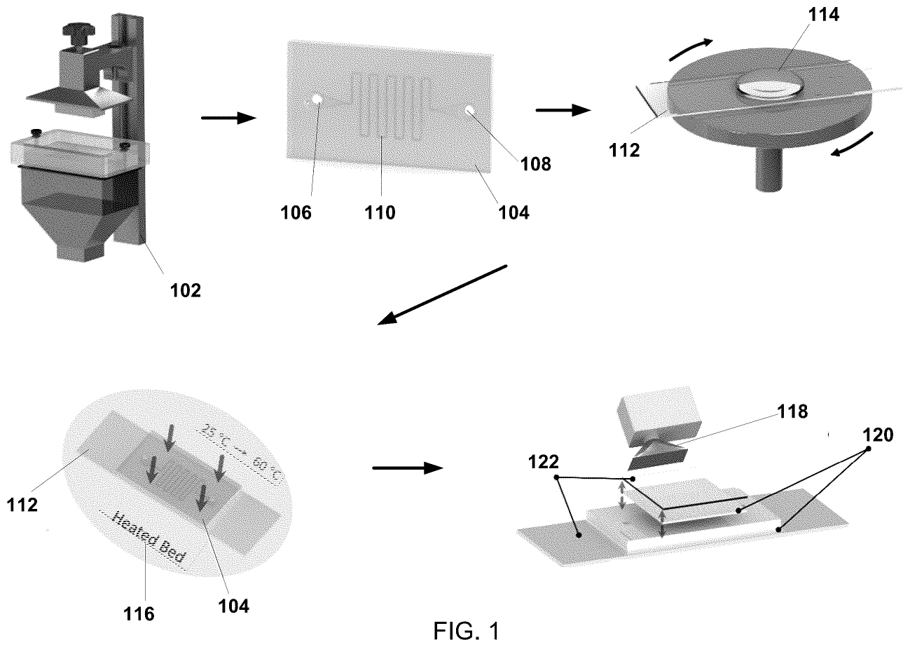

FIG. 1 illustrates an example of a microfluidic device fabrication process. A 3D printer 102 may print a microchannel layer 104 for the microfluidic device. The microchannel layer 104 may be designed in a computed aided design software, with instructions provided to the 3D printer 104 to form the microchannel layer 104. The microchannel layer 104 itself may be formed over multiple print layers layers, each defining a separate slice of the microchannel layer. The microchannel layer may include an inlet 106, outlet 108, and one or more grooves 110 which at least partially form channels of the microfluidic device. The grooves may be open on a surface of the microchannel layer and later be covered for form microchannels.

In various experimentation, the 3D printed models for microchannel layer 102 were designed via computer-aided design (CAD) software (SolidWorks version 2020, Dassault Systems, SolidWorks Corporation, Waltham, MA, USA). The design file was then saved as a stereolithography file (.STL) and imported into a LCD 3D printer for fabrication after slicing.

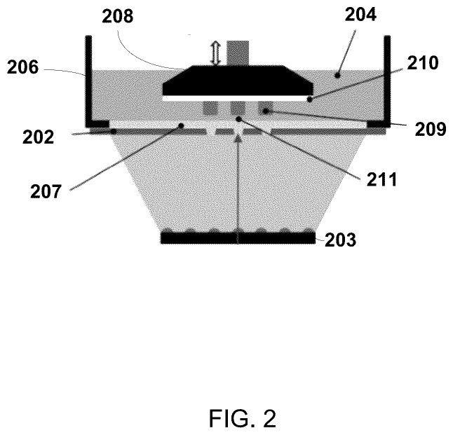

FIG. 2 illustrates an example of a 3D printer 104 enhanced for printing the microchannel layer. The 3D printer shown in FIG. 2 is a Vat Photopolymerization (VPP) printer. The 3D printer 104 may perform LCD-based photo-curing 3D printing with a bottom-up projection system. An LCD screen 202 projects light from a light source 203 the sliced 2D images to cure the liquid resins 204 in a resin tank 206. A Teflon release film 207 enables the non-adhesive separation process. Then a building plate 208 carries the printed objects 209 in Z-direction layer by layer 211.

At the beginning of printing, the building platform 208 moves down to be submerged into the uncured resin with a 100 μm gap above the Teflon film. Then the LCD screen 202 was turned on, and project the first image for first layer printing. Then the platform 208 will go up layer by layer until the printing process is finished. Most commercial building platforms were made of anodized aluminum, which makes the bottom surface of the printed part with high surface roughness. This issue significantly affects the transparency of microfluidic devices and makes microscopic observation extremely difficult. The issue was solved by attaching an acrylic panel 210 to the building platform. A releveling process was employed to ensure a proper printing process. Due to the acrylic panel 210 having a very clear surface, the attached surface of the printed part also forms a remarkably transparent surface.

Referring back to FIG. 1, a substrate layer 112 may receive a clear resin 114. The substrate layer 112 may be a layer which covers the grooves in the microchannel layer to from the microchannels of the microfluidic device. Alternatively or in addition, the substrate layer 112 may provide additional rigidity to the microchannel layer. The substrate layer may include glass, silicon, or a suitable polymer.

The resin 114 may be distributed on the substrate by spin coating. Spin coating ensures uniform distribution of the resin 114 on the substrate 112. The resin 114 may include the same type of resin that is used to print the grooves. However, a different photo-curable or thermal curable reason can also be used. The resin may be clear epoxy-based, acrylate-based, or any other suitable resin.

In various experimentation, a microscopic glass slide (25.4 mm×76.2 mm×1 mm) was spin-coated for 10 sec with clear resin at 1200 RPM, 300 RPM/s using Ni-Lo 5 XL Digital Spin Coater (Ni-Lo Scientific Inc., Ottawa, Canada). A thin layer of clear resin with a thickness of 45 μm was uniformly covered on the glass slide.

The printed microchannel layer 104 may be placed onto the coated substrate layer 112 such that the coated substrate layer covers the one or more grooves to form the microchannel(s). The combined microchannel layer and coated substrate may be heated for bonding. A heated bed 116 may be used to heat and bond a coated glass slide with a printed sample. In various experimentation, the temperature was gradually increased from 25° C. to 60° C. to reduce the bubbles formed between the glass slide and sample generated in the bonding process.

The resin between the substrate and the microchannel layer may be cured. For example, a UV light 118 may be used to cure the resin between two parts for additional adhesion.

After the bonding, clear resin 120 may be placed on the top surface and each side of the microfluidic device. A protection layer 122 may be added to one or both sides of the microfluidic device. The protection layer may be glass, silicon, a polymer, or some other suitable material. A second UV curing process may be employed to stick all components together and provide adequate adhesion. The same or different resin that is used between the substrate and printed microchannel layer may be used.

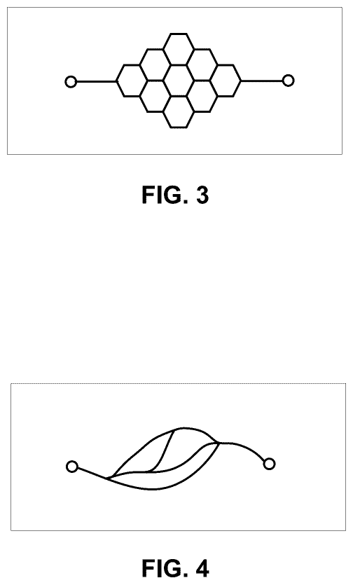

FIG. 3 illustrates an example of a microfluidic device with branching microchannels. FIG. 4 illustrates an example of a microfluidic device that mimics an artery. The microfluidic device may have an inlet and an outlet. In other examples, the microfluidic device may have multiple inlets and/or outlets. The channel(s) may fluidly connect the inlet and outlet. It should be appreciated that the depth and/or the width of the channel(s) may vary across the dimension of the microfluidic device. Thus each of the channels of the microfluidic device may have a different depth and/or a different width. Alternative or in addition, the depth and/or width of a channel may vary depth along its path. In some examples, the channels may be straight, as shown in FIG. 3. Alternatively or in addition, the channels may be curved to mimic an artery as shown in FIG. 4.

### Experimental Setup

Scanning electron microscopy—Scanning Electron Microscopy (SEM) images were collected by a Teneo Volume Scope SEM (Field Electron and lon Inc. USA) in backscattered electron mode to examine the microstructures of the printed channels. Before analysis, all test samples were placed on a set of aluminum stubs and bonded together with double side tape. The samples were then coated with a 10 nm thick gold-palladium layer using a vacuum sputter coater (Baltec SCD 005) for 60 sec at 0.1 mbar vacuum before observation. The accelerating voltage utilized was 5 KV with a beam current of 10 nA. All samples (two samples per group with different exposure times) were simulated using this SEM device to measure channel width, depth, and roughness accurately.

Microflow system—A NE-1010 programmable single syringe pump (Pump System Inc., Franklin, USA) was used to create a controlled fluid inflow at a flow rate of 60 μL/min. We used colored ink to visualize the microfluidics design pattern better and inspect for any leakage. The cancer cells were suspended in a culture media and influx inside the channel to create a single streamline of the cell. The optical observation was carried out using a microscope (EVOS™ FL Auto Imaging System) to record the flow and formation of cell streamline inside the microchannels.

Cancer Cell-line—We chose MDA-MB-231, a Triple Negative Breast Cancer cell line, based on our prior experiments. The cells were cultured in a controlled environment (37° C., 5% CO₂, and 80% relative humidity). Once the cell reaches 90% confluency, we use trypsinization to dislodge the cell from the surface of the T-25 plate.

### Results and Discussion

Optimization of Printing Resolution—Due to the photo-curing process, the curing time for each layer can have a significant effect on printing resolution. Two test samples with several grooves with different widths and depths were designed to characterize the feature resolution of the LCD printer in the horizontal and vertical directions. In order to optimally enhance the printer resolution, the thickness was set for each layer as 10 μm. By changing curing times ranging from 1 sec to 3 sec, we discovered the curing time for the most promising printing resolution in vertical and lateral layers. The printed objects were observed and measured via an SEM imaging system.

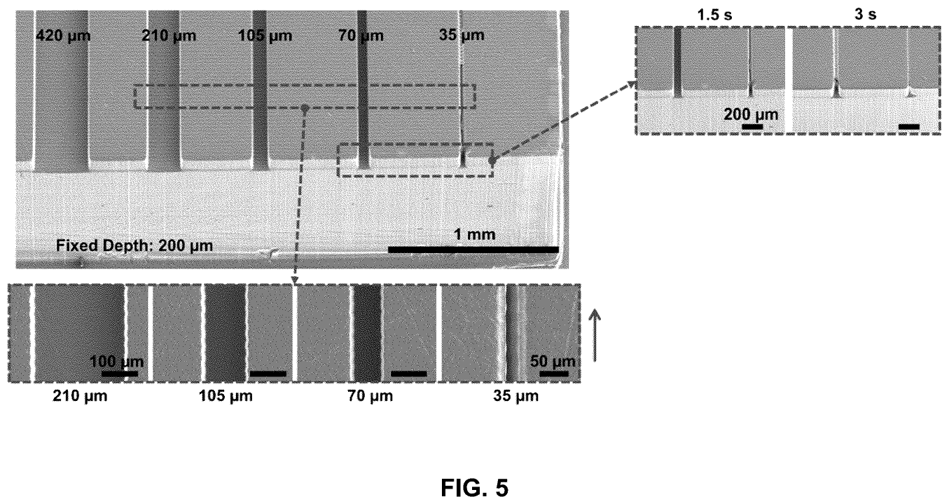

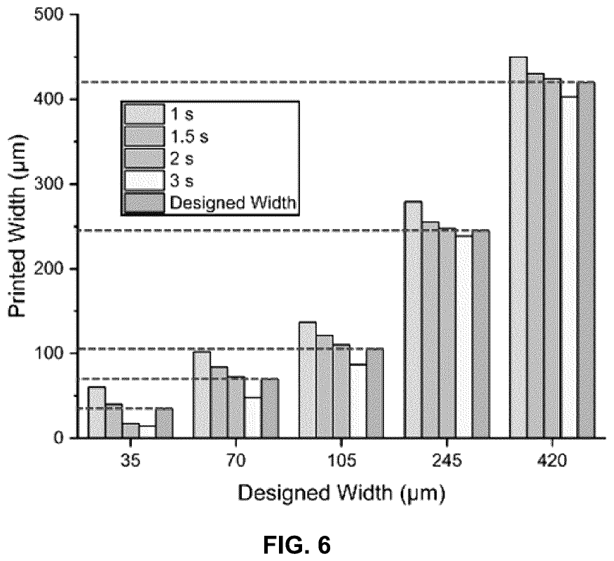

FIG. 5 illustrates an example of a scanning electron microscope image of a printed microchannel layer with different widths of grooves. FIG. 6 illustrates a chart showing a relationship between designed widths and printed widths of different curing times.

For horizontal resolution, a sample was designed and printed with different grooves with widths of 420 μm, 210 μm, 105 μm, 70 μm, and 35 μm. All grooves were designed with the same depth of 200 μm, and the smallest visible groove was about 40 μm. For the horizontal features, it was encountered that the measured widths were different from the designed dimension due to curing time. As shown in the zoom in photo on the right, the grooves with designed widths of 70 μm and 35 μm were printed correctly by utilizing a curing time of 1.5 sec. However, when using 3 sec as the curing time, the features cannot be printed as desired due to over-curing. As show in FIG. 6, for all the samples, the printed widths could be smaller or greater than the designed widths due to curing time. As a result, 2 sec was the desired curing time in our microfluidics printing. For some channel printing with a width less than 70 μm, additional printing tests with more curing time need to be conducted.

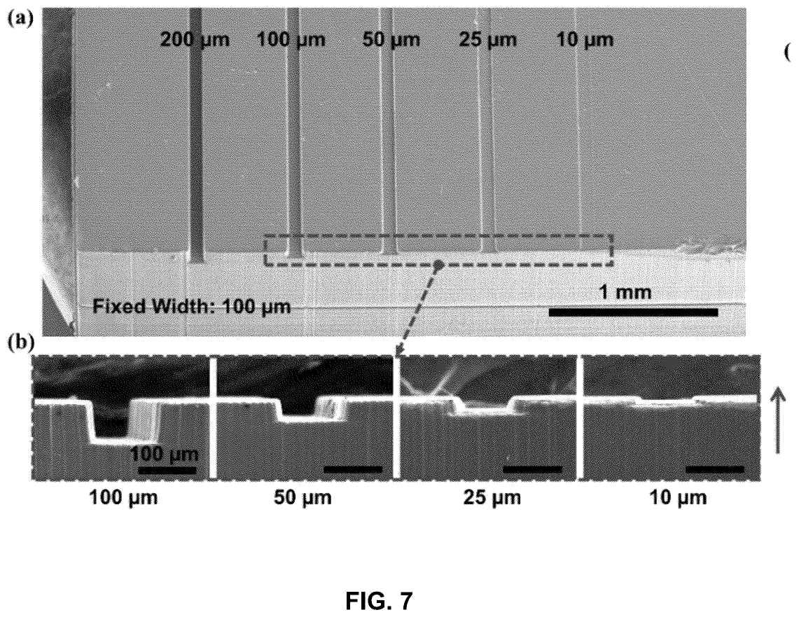

FIG. 7 illustrates an example of the microchannel layer having grooves of various depths. For vertical resolution, a sample was designed and printed with different grooves with the depths of 200 μm, 100 μm, 50 μm, 25 μm, and 10 μm. The grooves were designed with the same width of 100 μm. As illustrated in FIG. 7, grooves with different depths were printed correctly, and the smallest depth of the groove was about 10 μm. For the vertical features, it was found that the measured depths were almost the same as the designed dimension by utilizing different curing times.

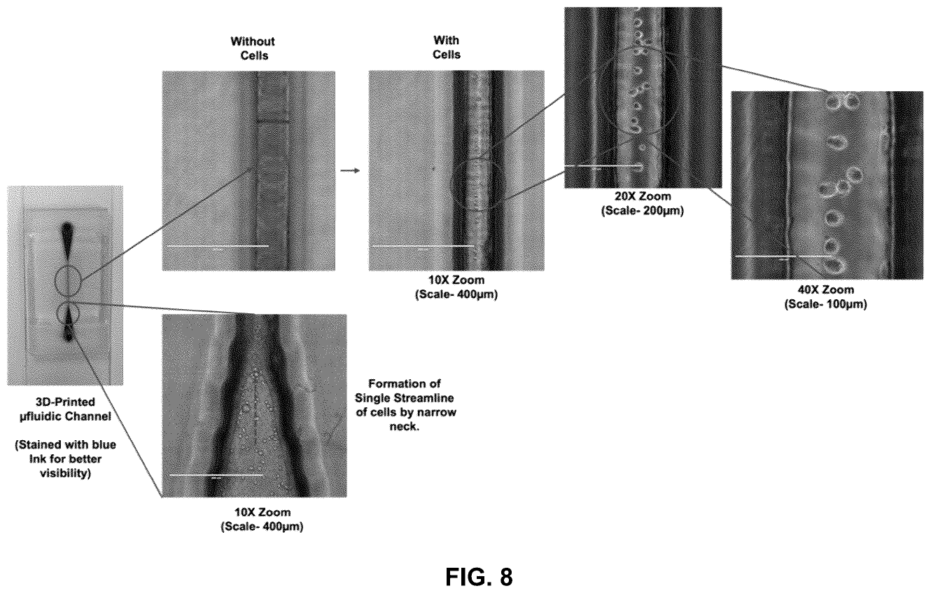

FIG. 8 illustrates an example of a printed microfluidic channel with and without cells and at various magnifications. The microscopic image of the cells inside the microchannel has been shown at different magnifications in FIG. 8. We inspected the MDA-MB-231 cells under an inverted microscope at different magnifications and captured the cell image to observe the formation of a single streamline at a concentration of 105 cells/ml. This final suspension of cell in media was introduced from the inlet of the 3D printed micro-channel using a syringe pump. The inlet converges into a narrow 100 μm wide and 1.2 mm long channel. This convergence geometrically allows the formation of streamlined cell flow. So, we demonstrated that at correct cell dilution and flow rate we can create single-cell streamline and eventually, explore various cell manipulation techniques at the micro-level and study the interaction between the individual cell or batch of cells (a few 100's of a cell) with different drug or macro-molecules for precise diagnosis and treatment.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

While various embodiments have been described, it will be apparent to those of ordinary skill in the art that many more embodiments and implementations are possible. Accordingly, the embodiments described herein are examples, not the only possible embodiments and implementations.

What is claimed is:

1. A method, comprising:
printing a microchannel layer using the 3D printer, the microchannel layer having an inlet and an outlet fluidly connected by at least one groove.
spin coating a substrate layer with a clear resin;
placing the printed microchannel layer onto the coated substrate layer such that the coated substrate layer covers the at least one groove to form at least one microchannel;
heating the microchannel layer and coated substrate layer; and
curing the resin between the substrate layer and microchannel layer with a UV light.

2. The method of claim 1, wherein the 3D printer is a Vat Photopolymerization (VPP) printer.

3. The method of claim 2, wherein the VPP printer has an acrylic panel for a build plate, wherein printing the microchannel layer comprising:
printing the microchannel layer onto the acrylic panel to form a transparent microchannel layer.

4. The method of claim 1, at least one groove has a depth between 10 and 200 micro-meters.

5. The method of claim 1, wherein at least one groove has a width between 30 and 500 micro-meters.

6. The method of claim 1, wherein the at least one groove comprises a plurality of grooves having different respective depths.

7. The method of claim 1, wherein the at least one groove comprises a plurality of grooves having different respective widths.

8. The method of claim 1, wherein the at least one microchannel comprises a plurality of microchannels connected by a plurality of branches, wherein the microchannel branch out and then converge between in the inlet and the outlet respectively.

9. The method of claim 8, wherein the microchannels are curved.

10. The method of claim 1, wherein the substrate layer is glass.

11. The method of claim 1, wherein the substrate layer is silicone.

12. The method of claim 1, wherein the substrate layer is a polymer.
